(19) United States
(12) Patent Application Publication
(10) Pub. No.: US 2025/0260157 A1
(43) Pub. Date: Aug. 14, 2025

(54) ANTENNA MODULE AND COMMUNICATION APPARATUS INCLUDING THE SAME

(71) Applicant: Murata Manufacturing Co., Ltd., Nagaokakyo-shi (JP)

(72) Inventors: Yuya DOKAI, Nagaokakyo-shi (JP); Kengo ONAKA, Nagaokakyo-shi (JP); Kaoru SUDO, Nagaokakyo-shi (JP); Kazushige SATO, Nagaokakyo-shi (JP); Hirotsugu MORI, Nagaokakyo-shi (JP)

(73) Assignee: Murata Manufacturing Co., Ltd., Nagaokakyo-shi (JP)

(21) Appl. No.: 19/195,739

(22) Filed: May 1, 2025

Related U.S. Application Data
(63) Continuation of application No. PCT/JP2023/034027, filed on Sep. 20, 2023.

(30) Foreign Application Priority Data
Nov. 16, 2022 (JP) 2022-183529

(51) Int. Cl. H01Q 1/24; H01Q 1/52; H01Q 9/04

(52) U.S. Cl. CPC H01Q 1/243; H01Q 1/526; H01Q 9/0414

(57) ABSTRACT

An antenna module is configured to receive a signal from a baseband circuit and to radiate a radio wave. The antenna module includes a dielectric substrate, radiating elements, and a connector. The dielectric substrate includes planar sections having different normal directions. A first radiating element is disposed in or on the planar section. A second radiating element is disposed in or on the planar section. The antenna module is configured to transfer a radio-frequency signal to a third radiating element, which is externally disposed, via the connector. The size of the second radiating element is smaller than that of the third radiating element.

### CROSS-REFERENCE TO RELATED APPLICATIONS

The present application is a continuation of international application No. PCT/JP2023/034027, filed Sep. 20, 2023, and claims priority to Japanese patent application 2022-183529, filed Nov. 16, 2022, the entire contents of each of which being incorporated herein by reference.

### BACKGROUND

### 1. Technical Field

The present disclosure relates to an antenna module and a communication apparatus including the same, and more particularly, to a technology for reducing the height of an antenna module.

### 2. Description of the Related Art

International Publication No. 2020/031776 discloses the following antenna module. Two substrates whose normal directions are different from each other are disposed to form a substantially L-like shape, so that the antenna module can radiate a radio wave in two directions. Additionally, in each substrate, two radiating elements of different sizes are stacked on each other, so that the antenna module can support dual-band transmission to radiate a radio wave of two frequency bands.

### SUMMARY

The above-described type of antenna module may be applicable to a mobile communication apparatus represented by a mobile phone or a smartphone. In accordance with a reduced size of a mobile communication apparatus and/or highly densified internal devices inside the communication apparatus, an even smaller and thinner antenna module is desired.

When the antenna module is disposed in a smartphone, for example, to radiate a radio wave in the direction of the side surface of the smartphone, the area of a substrate is decreased in accordance with a smaller height of the antenna module. For a patch antenna using a planar radiating element, a smaller area of the substrate, that is, a smaller area of a ground electrode, may lower the antenna gain. In particular, for a dual-band antenna module that can radiate a radio wave of two frequency bands, a smaller area of the ground electrode may be more likely to influence the antenna gain of the antenna on the lower frequency side including a relatively large radiating element.

The present disclosure has been made to address the above-described issue. Embodiments are directed to making it less likely to lower the gain of an antenna on a lower frequency side in a dual-band antenna module that can radiate a radio wave in two different directions.

An antenna module according to an aspect of the present disclosure includes a dielectric substrate, first through third radiating elements, and a first connector. The dielectric substrate includes first and second planar sections. The normal direction to the first planar section and that to the second planar section are different from each other. The first and second radiating elements are disposed in or on the first planar section. The third radiating element is disposed in or on the second planar section. The antenna module is able to transfer a radio-frequency signal to a fourth radiating element via the first connector. The fourth radiating element is disposed externally to the dielectric substrate. The size of the first radiating element is smaller than that of the second radiating element. The size of the third radiating element is smaller than that of the fourth radiating element. The fourth radiating element is attachable to and detachable from the first connector.

An antenna module according to another aspect of the present disclosure is configured to receive a signal from a baseband circuit and to radiate a radio wave. The antenna module includes a dielectric substrate, fifth and sixth radiating elements, and a first connector. The dielectric substrate includes first and second planar sections. The normal direction to the first planar section and that to the second planar section are different from each other. The fifth radiating element is disposed in or on the first planar section. The sixth radiating element is disposed in or on the second planar section. The antenna module is able to transfer a radio-frequency signal to a seventh radiating element via the first connector. The seventh radiating element is externally disposed. The size of the sixth radiating element is smaller than that of the seventh radiating element.

In an antenna module according to the disclosure, a radiating element (third radiating element) on a relatively high frequency side is only disposed in or on the second planar section of the dielectric substrate. A radio-frequency signal is transferred to a radiating element (fourth radiating element) on a relatively low frequency side by using a connector. With this configuration, the radiating element on the lower frequency side, that is, a relatively large radiating element, which is likely to lower the gain due to a limitation on the area of the substrate, can be disposed outside the dielectric substrate. It is thus possible to suppress the degradation of the antenna gain of the radiating element on the lower frequency side, which is caused by a limitation on the area of the substrate, in a dual-band antenna module that can radiate a radio wave in two different directions.

### BRIEF DESCRIPTION OF THE DRAWINGS

FIG. 1 is a block diagram of a communication apparatus to which an antenna module of a first embodiment is applied;

FIG. 2 is a perspective view of the antenna module in FIG. 1;

FIG. 3 is a transparent side view of the antenna module in FIG. 2 as viewed from the X-axis direction;

FIG. 4 is a top view of the antenna module in FIG. 2 as viewed from the Z-axis direction;

FIG. 5 is a transparent side view of an antenna module according to a second embodiment;

FIG. 6 is a perspective view of an antenna module according to a modified example;

FIG. 7 is a transparent side view of the antenna module in FIG. 6 as viewed from the X-axis direction;

FIG. 8 is a side view of the antenna module in FIG. 6 as viewed from the Y-axis direction; and

FIG. 9 is a transparent side view of an antenna module according to a third embodiment.

### DETAILED DESCRIPTION

Embodiments of the present disclosure will be described below in detail with reference to the drawings. The same or corresponding elements in the drawings are designated by like reference numeral and an explanation thereof will not be repeated.

### First Embodiment

### Basic Configuration of Communication Apparatus

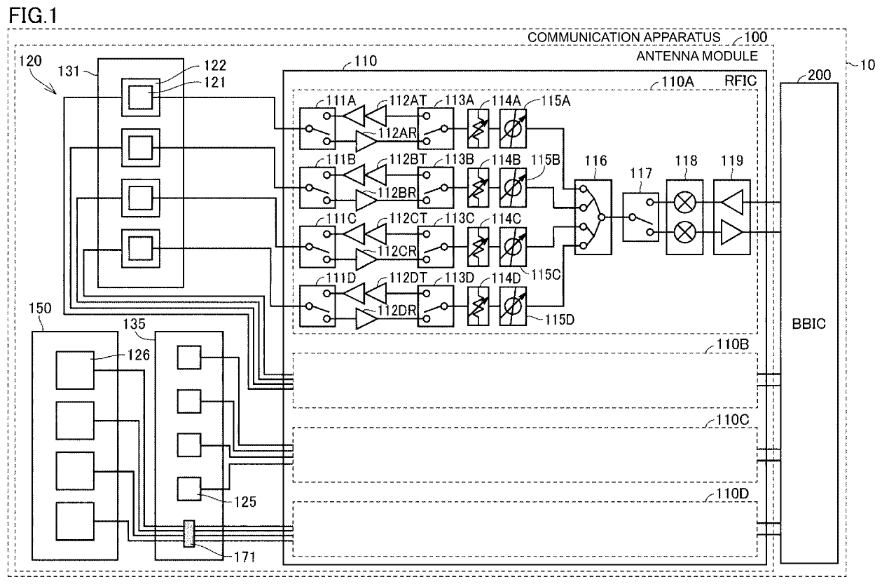

FIG. 1 is a block diagram of a communication apparatus 10 to which an antenna module 100 of a first embodiment is applied. The communication apparatus 10 is a mobile terminal, such as a mobile phone, a smartphone, or a tablet, or a personal computer having a communication function, for example. An example of the frequency band of a radio wave used for the antenna module 100 of the first embodiment is millimeter bands, such as those having 28 GHZ, 39 GHz, and 60 GHz, for example, as the center frequency. A frequency band other than the millimeter bands may be applied to a radio wave used for the antenna module 100.

As shown in FIG. 1, the communication apparatus 10 includes the antenna module 100 and a baseband integrated circuit (BBIC) 200. The antenna module 100 includes a radio frequency integrated circuit (RFIC) 110, which is an example of a feeder device, and an antenna device 120. The communication apparatus 10 up-converts an intermediate frequency (IF) signal, which is transferred from the BBIC 200 to the antenna module 100, into a radio-frequency signal and radiates it from the antenna device 120. The communication apparatus 10 also down-converts a radio-frequency signal received by the antenna device 120 and processes the down-converted signal by using the BBIC 200.

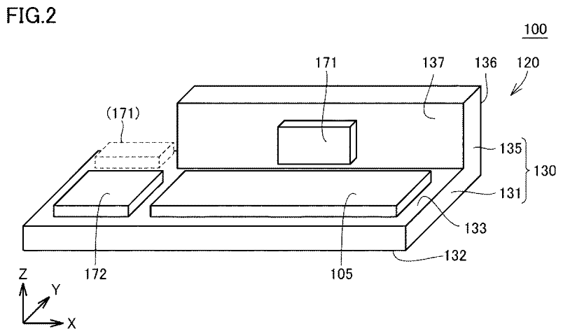

The antenna device 120 includes a planar section 131 in or on which radiating elements 121 and 122 are disposed and a planar section 135 in or on which a radiating element 125 is disposed and on which a connector 171 is disposed. As will be discussed with reference to FIG. 2, the planar sections 131 and 135 form a dielectric substrate 130. The antenna module 100 may also include a dielectric substrate 150 in or on which a radiating element 126 is disposed.

In or on each substrate, at least one radiating element is disposed. In the example in FIG. 1, four radiating elements 121 and four radiating elements 122 are disposed in the planar section 131. Four radiating elements 125 are disposed in the planar section 135. Four radiating elements 126 are disposed in the dielectric substrate 150. The number of radiating elements to be disposed in each substrate is not limited to four. Additionally, in the example in FIG. 1, the radiating elements in each substrate are aligned and arranged in a linear array form. However, the radiating elements in each substrate may be arranged in a two-dimensional array form. Alternatively, a single radiating element may be disposed in each substrate.

The radiating elements 121, 122, 125, and 126 are planar patch antennas having a circular, elliptical, or polygonal shape. The first embodiment will be explained, assuming that the radiating elements are microstrip antennas having a substantially square shape.

In the planar section 131, the size of the radiating element 121 is smaller than that of the radiating element 122. The frequency band of a radio wave radiated from the radiating element 121 is thus higher than that from the radiating element 122. Likewise, the size of the radiating element 125 is smaller than that of the radiating element 126. The frequency band of a radio wave radiated from the radiating element 125 is thus higher than that from the radiating element 126. In the antenna module 100 of the first embodiment, the frequency band of a radio wave radiated from the radiating element 121 is the same as that from the radiating element 125, while the frequency band of a radio wave radiated from the radiating element 122 is the same as that from the radiating element 126. Hence, the antenna module 100 is what is known as a dual-band antenna module that can radiate a radio wave of two different frequency bands.

The RFIC 110 includes four feeder circuits 110A through 110D. The feeder circuit 110A is a circuit for supplying a radio-frequency signal to the radiating elements 121 of the planar section 131. The feeder circuit 110B is a circuit for supplying a radio-frequency signal to the radiating elements 122 of the planar section 131. The feeder circuit 110C is a circuit for supplying a radio-frequency signal to the radiating elements 125 of the planar section 135. The feeder circuit 110D is a circuit for supplying a radio-frequency signal to the radiating elements 126 of the dielectric substrate 150. The internal configurations of the feeder circuits 110A through 110D are the same. In FIG. 1, for easy representation, the detailed configuration is shown only for the feeder circuit 110A, and those of the feeder circuits 110B through 110D are not shown. The function of the feeder circuit 110A will be explained below as a representative example.

The feeder circuit 110A includes switches 111A through 111D, 113A through 113D, and 117, power amplifiers 112AT through 112DT, low-noise amplifiers 112AR through 112DR, attenuators 114A through 114D, phase shifters 115A through 115D, a signal combiner/splitter 116, a mixer 118, and an amplifier circuit 119.

When transmitting a radio-frequency signal, the switches 111A through 111D and 113A through 113D are respectively switched to the power amplifiers 112AT through 112DT, and the switch 117 is connected to a transmit amplifier of the amplifier circuit 119. When receiving a radio-frequency signal, the switches 111A through 111D and 113A through 113D are respectively switched to the low-noise amplifiers 112AR through 112DR, and the switch 117 is connected to a receive amplifier of the amplifier circuit 119.

An IF signal transferred from the BBIC 200 is amplified in the amplifier circuit 119 and is up-converted to a radio-frequency signal in the mixer 118. A transmission signal, which is the up-converted radio-frequency signal, is split into four signals in the signal combiner/splitter 116, which pass through corresponding signal paths and are supplied to the different radiating elements 121. The degree of phase shifting in the phase shifters 115A through 115D disposed in the signal paths are individually adjusted, thereby making it possible to control the directivity of the waves to be output from the radiating elements 121. The attenuators 114A through 114D adjust the strength of the transmission signal.

Reception signals, which are radio-frequency signals received by the radiating elements 121, are transferred to the feeder circuit 110A of the RFIC 110, pass through the four different signal paths, and are combined in the signal combiner/splitter 116. The combined reception signal is down-converted in the mixer 118 and is amplified in the amplifier circuit 119, and is then transferred to the BBIC 200.

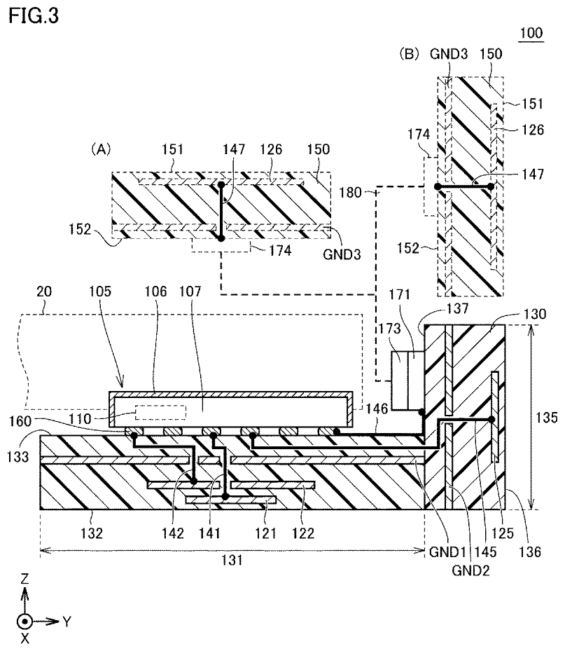

A feeder line extending from the feeder circuit 110D is connected to the connector 171 of the planar section 135. A feeder cable 180 is connected to the connector 171 to transfer a radio-frequency signal to the radiating elements 126 in the dielectric substrate 150, which will be discussed later with reference to FIG. 3. That is, a radio-frequency signal is supplied to the radiating elements 126 from the feeder circuit 110D via the connector 171. The dielectric substrate 150 and the radiating elements 126 may be external elements outside the antenna module 100, in which case, they are detachably attached to the antenna module 100 using the connector 171.

The RFIC 110 is formed as, for example, a one-chip integrated circuit (IC) component including the above-described circuit configuration. The RFIC 110 may alternatively be formed as multiple IC components for the individual feeder circuits. Alternatively, the RFIC 110 may be formed as multiple one-chip IC components for the individual radiating elements, each of which corresponds to devices (switches, a power amplifier, a low-noise amplifier, an attenuator, and a phase shifter).

### Structure of Antenna Module

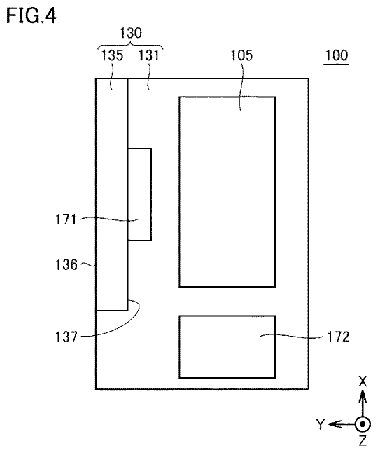

The detailed configuration of the antenna module 100 according to the first embodiment will be described below with reference to FIGS. 2 through 4. FIG. 2 is a perspective view of the antenna module 100 according to the first embodiment. FIG. 3 is a transparent side view of the antenna module 100 in FIG. 2 as viewed from the positive direction of the X axis. FIG. 4 is a plan view of the antenna module 100 in FIG. 2 as viewed from the positive direction of the Z axis.

As illustrated in FIGS. 2 through 4, the dielectric substrate 130 is constituted by the planar sections 131 and 135, as discussed above. The planar sections 131 and 135 forming the dielectric substrate 130 are formed of a low temperature co-fired ceramics (LTCC) multilayer substrate, a multilayer resin substrate formed by stacking multiple resin layers made of an epoxy or polyimide resin, for example, a multilayer resin substrate formed by stacking multiple resin layers made of a liquid crystal polymer (LCP) having a lower dielectric constant, a multilayer resin substrate formed by stacking multiple resin layers made of a fluorine resin, a multilayer resin substrate formed by stacking multiple resin layers made of a polyethylene terephthalate (PET) material, or a ceramics multilayer substrate made of ceramics other than the LTCC. The planar sections 131 and 135 may be a single layer substrate instead of a multilayer substrate.

The planar section 131 is a planar substrate having substantially rectangular main surfaces 132 and 133 that are normal to the Z-axis direction. In FIGS. 2 through 4, the long sides of the planar section 131 are set to the X axis, while the short sides thereof are set to the Y axis.

On the main surface 133 of the planar section 131 in the positive direction of the Z axis, a system-in-package (SiP) module 105 and a connector 172 are mounted. In the antenna module 100 of the first embodiment, the SiP module 105 and the connector 172 are disposed on the main surface 133 separately from each other in the X-axis direction. As illustrated in FIGS. 2 and 4, the SiP module 105 is disposed adjacent to the planar section 135 in the Y-axis direction.

The connector 172 is a connection member used for connecting the antenna module 100 to an external device, such as a mounting substrate 20. The connector 172 receives an IF signal from the BBIC 200 disposed on the mounting substrate 20 and transfers the received IF signal to the SiP module 105.

The SiP module 105 has a built-in circuit including the RFIC 110 and other devices, such as a power module IC and a power inductor, mounted on a substrate. As shown in FIG. 3, this built-in circuit is sealed with a resin 107 and is electrically connected to the planar section 131 using a connection member, such as solder bumps 160. A shield member 106 is provided on the periphery of the SiP module 105 to contain, i.e., prevent leakage of, an electromagnetic wave therein. The shield member 106 can prevent a leakage of an electromagnetic wave generated in the circuit within the SiP module 105 so as to reduce the influence of an electromagnetic wave on external devices. The shield member 106 can also prevent the entry of electromagnetic noise from the outside into the circuit within the SiP module 105.

The radiating element 121 is disposed closer to the main surface 132 of the planar section 131 in the negative direction of the Z axis. The radiating element 121 may be disposed on an inner layer of the planar section 131, as shown in FIG. 3, or may be exposed on the main surface 132. In the planar section 131, a ground electrode GND1 is disposed on the entirety of a layer, which is positioned closer to the main surface 133 than the radiating element 121 is, so as to face the radiating element 121. The radiating element 122 is disposed on a layer between the radiating element 121 and the ground electrode GND1 so as to face the radiating element 121 and the ground electrode GND1.

A radio-frequency signal is transferred from the RFIC 110 to the radiating element 121 via a feeder line 141. The feeder line 141 extends from a solder bump 160 of the SiP module 105, passes through the ground electrode GND1 and the radiating element 122, and is connected to the radiating element 121. A radio-frequency signal is transferred from the RFIC 110 to the radiating element 122 via a feeder line 142. The feeder line 142 extends from a solder bump 160 of the SiP module 105, passes through the ground electrode GND1, and is connected to the radiating element 122. While the planar section 131 has radiating elements 121 and 122 stacked on each other, as shown in FIG. 3, the radiating elements 121 and 122 may be separately disposed.

The planar section 135 is a planar substrate having substantially rectangular main surfaces 136 and 137 that are normal to the Y-axis direction. That is, a normal direction to the planar section 131 is perpendicular to a normal direction to the planar section 135. The long sides of the planar section 135 are parallel with the X axis and the short sides are parallel with the Z axis. The planar section 135 is connected to the planar section 131 at the side surface of the planar section 131 in the positive direction of the Y axis.

The planar section 131 is positioned closer to the main surface 137 of the planar section 135. That is, the dielectric substrate 130 has a substantially U-like shape as viewed from the X-axis direction. The dimension of the planar section 135 in the Y-axis direction is shorter than that of the planar section 131 in the Y-axis direction. The connector 172 on the planar section 131 is disposed at a position at which it does not overlap the planar section 135 placed on the planar section 131 as viewed from the Y-axis direction. Disposing the connector 172 at such a position can reduce the interference of the antenna module 100 with the devices mounted on the mounting substrate 20 when the antenna module 100 is connected to the mounting substrate 20.

The connector 171 is disposed on the main surface 137 of the planar section 135 in the negative direction of the Y axis. The connector 171 is disposed on the main surface 137 such that it at least partially overlaps the SiP module 105 as viewed in the Y-axis direction. Disposing the connector 171 in this manner can make the dimension of the antenna module 100 in the Z-axis direction smaller than the configuration in which the connector 171 does not overlap the SiP module 105, thereby making it possible to reduce the height of the antenna module 100. As indicated by the broken lines in FIG. 2, the connector 171 may be disposed on the main surface 133 of the planar section 131.

As illustrated in FIG. 3, a radio-frequency signal to be supplied to the radiating element 126 of the dielectric substrate 150 is transferred from the RFIC 110 to the connector 171 via a feeder line 146. The feeder line 146 extends from a solder bump 160 of the SiP module 105 to the main surface 133 of the planar section 131 and to the main surface 137 of the planar section 135 and is then connected to the connector 171. The feeder line 146 may be laid to extend on the inner layers of the planar sections 131 and 135. A connector 173 provided at an end portion of the feeder cable 180, which is used to transfer a radio-frequency signal to the radiating element 126 of the dielectric substrate 150, is connected to the connector 171.

The output terminal from the SiP module 105 extends on the main surface 133 in the Y-axis direction, while the input terminal into the connector 171 extends on the main surface 137 in the Z-axis direction. In this manner, the output direction of a signal from the SiP module 105 and the input direction of a signal into the connector 171 are perpendicular to each other, thereby preventing unnecessary coupling between the SiP module 105 and the connector 171. This can make it less likely to degrade the isolation between the radiating elements of the dielectric substrate 150.

As seen in the normal direction to the planar section 135, that is, in the Y-axis direction, the connector 171 has a substantially rectangular shape having long sides and short sides. In the antenna module 100, the connector 171 is disposed with its long sides extending along the X-axis direction. In other words, the connector 171 is disposed such that a line extending in the direction of its short sides intersects with the planar section 131. With this arrangement, the height of the antenna module 100, that is, the dimension of the antenna module 100 in the Z-axis direction, can be made smaller than the configuration in which the connector 171 is disposed with its long sides extending along the Z-axis direction. This contributes to reducing the height of the antenna module 100.

As seen in the normal direction to the planar section 131 (in the Z-axis direction), the connector 171 is adjacent to the SiP module 105 and the planar section 131 in the direction of their short sides (in the Y-axis direction). In other words, the connector 171 is disposed with its long sides facing the long sides of the SiP module 105. Disposing the SiP module 105 close to the planar section 135 can decrease the length of the feeder line 146 from the SiP module 105 to the connector 171. This can lower the attenuation of a radio-frequency signal in the feeder line 146, thereby reducing a transmission loss. Additionally, by disposing the SiP module 105 and the connector 171 with their long sides facing each other, the flexibility in laying the feeder line 146 can be increased when multiple radiating elements 126 are disposed.

The radiating element 125 is disposed on a layer close to the main surface 136 of the planar section 135 in the positive direction of the Y axis. The radiating element 125 may be disposed inside the planar section 135 as shown in FIG. 3, or may be exposed on the main surface 136. On a layer between the radiating element 125 and the main surface 137, a ground electrode GND2 is disposed along the entirety of a layer of the planar section 135. The ground electrode GND1 of the planar section 131 and the ground electrode GND2 of the planar section 135 may be disconnected from each other, as shown in FIG. 3, if they are connected to a ground electrode of the mounting substrate 20. However, the ground electrodes GND1 and GND2 may be directly connected to each other inside the dielectric substrate 130.

A radio-frequency signal is supplied from the RFIC 110 to the radiating element 125 via a feeder line 145. The feeder line 145 extends from a solder bump 160 to a wiring layer between the ground electrode GND1 and the main surface 133 of the planar section 131, passes through the ground electrode GND2 of the planar section 135, and is connected to the radiating element 125.

The dielectric substrate 150 is a substrate provided separately from the dielectric substrate 130. The dielectric substrate 150 is formed in a planar shape and has substantially rectangular main surfaces 151 and 152. The dielectric substrate 150 is also formed of an LTCC, for example, as in the dielectric substrate 130.

As illustrated in FIG. 3, the radiating element 126 is disposed on a layer close to the main surface 151 of the dielectric substrate 150. The radiating element 126 may be disposed on an inner layer of the dielectric substrate 150 or may be exposed on the main surface 151. A ground electrode GND3 may be between the radiating element 126 and the main surface 152. Alternatively, a conducting member of a housing, for example, for a device disposed inside the communication apparatus 10 may be used as the ground electrode GND3.

A connector 174 is disposed on the main surface 152 of the dielectric substrate 150. The radiating element 126 is connected to the connector 174 using a feeder line 147. One end portion of the flexible feeder cable 180 is connected to the connector 174. The connector 173 is connected to the other end portion of the feeder cable 180. As a result of connecting the connector 173 to the connector 171 mounted on the planar section 135 of the dielectric substrate 130 as described above, a radio-frequency signal is transferred from the RFIC 110 to the radiating element 126 via the feeder cable 180 and the feeder line 147.

Since the dielectric substrate 150 is separately provided from the dielectric substrate 130, a normal direction to the main surface 151, which is the radiating plane for a radio wave, can be set to a desired direction. FIG. 3 shows a case in which the dielectric substrate 150 is arranged so that the direction of a normal direction to the main surface 151 is the positive direction of the Z axis, as indicated by (A) in FIG. 3, and a case in which the dielectric substrate 150 is arranged so that the normal direction to the main surface 151 is the positive direction of the Y axis, as indicated by (B) in FIG. 3.

In an antenna module that can radiate a radio wave in two directions, such as the above-described antenna module, the dimension of the antenna module in the thickness direction, that is, in the Z-axis direction, may be limited to a small size in accordance with a thinner communication apparatus including the antenna module. In this case, in particular, the area of the substrate on which the radiating element radiating a radio wave in the direction of the side surface of the communication apparatus is disposed, and more specifically, the area of the ground electrode, is limited to a small size.

When a planar patch antenna is used as the radiating element, as the ground electrode has a smaller area, the antenna gain typically tends to be lowered. Accordingly, if the height of the antenna module is decreased, the antenna characteristics are likely to be degraded. Especially for a stack-type dual-band patch antenna, a smaller area of the ground electrode may be more likely to influence the antenna gain of a relatively large radiating element on the lower frequency side.

To address this issue, in the antenna module 100 of the first embodiment, regarding the radiating elements which radiate a radio wave in the direction of the side surface, the radiating element 125 on the higher frequency side is only disposed on the fixed dielectric substrate 130, while the radiating element 126 on the lower frequency side is disposed on the dielectric substrate 150, which is separately provided from the dielectric substrate 130. Then, the connector 171 is provided on the dielectric substrate 130 to transfer a radio-frequency signal to the radiating element 126 of the separately provided dielectric substrate 150.

With the above-described configuration, in the communication apparatus 10, the flexibility in arranging the radiating element 126 on the lower frequency side can be enhanced. By providing the radiating element 126 externally to the dielectric substrate and separate from the radiating element 125, the radiating element 126 can be disposed where more space is available in the communication apparatus 10. This can ease the limitation on the area of the ground electrode for the radiating element 126, compared with the configuration in which the radiating element 126 and the radiating element 125 are stacked. Hence, in a dual-band antenna module that can radiate a radio wave in two different directions, the antenna gain on the lower frequency side is less likely to be lowered.

The planar section 131 and the planar section 135 in the first embodiment respectively correspond to a first planar section and a second planar section in the disclosure. The radiating elements 121, 122, 125, and 126 in the first embodiment respectively correspond to a first radiating element, a second radiating element, a third radiating element, and a fourth radiating element in the disclosure. The connector 171 and the connector 172 in the first embodiment respectively correspond to a first connector and a second connector in the disclosure. The SiP module 105 in the first embodiment corresponds to a control circuit in the disclosure. The main surfaces 132, 133, 136, and 137 respectively correspond to a first surface, a second surface, a third surface, and a fourth surface in the disclosure.

### Second Embodiment

In a second embodiment, an example in which a dielectric substrate is formed by using a flexible substrate having flexibility will be described below.

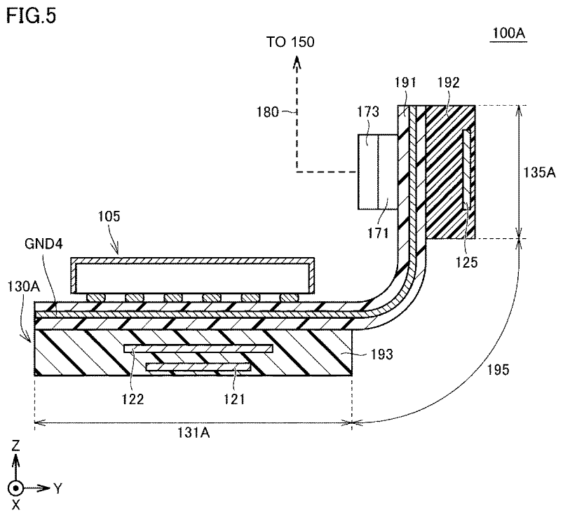

FIG. 5 is a transparent side view of an antenna module 100A according to the second embodiment. The antenna module 100A is different from the antenna module 100 of the first embodiment mainly in that the dielectric substrate 130 is replaced by a dielectric substrate 130A. The configurations of the other elements in the antenna module 100A are basically similar to those of the antenna module 100, and an explanation of these elements will not be repeated. For easy representation, some of the same elements as those in FIG. 3 are not shown in FIG. 5.

As illustrated in FIG. 5, the dielectric substrate 130A of the antenna module 100A is constituted by a flexible substrate 191 and substrates 192 and 193. The flexible substrate 191 is a planar-shaped multilayer substrate made of a flexible resin. The flexible substrate 191 can bend so that the normal direction to the main surface is variable. In the antenna module 100A, as shown in FIG. 5, the flexible substrate 191 is bent from a portion extending in the Y-axis direction and then extends in the Z-axis direction. A ground electrode GND4 is provided on the entirety of an inner layer of the flexible substrate 191.

The dielectric substrate 130A includes a planar section 131A extending in the Y-axis direction, a planar section 135A extending in the Z-axis direction, and a connecting section 195 that connects the planar sections 131A and 135A to each other. The connecting section 195 corresponds to a bending portion of the flexible substrate 191.

The planar section 131A also includes the substrate 193 at a position corresponding to a portion of the flexible substrate 191 extending in the Y-axis direction. The substrate 193 is disposed on the main surface of the flexible substrate 191 in the negative direction of the Z axis. The substrate 193 is also formed of an LTCC or a resin, for example, as in the dielectric substrate 130 of the antenna module 100 of the first embodiment. As shown herein, radiating elements 121 and 122 are disposed in the substrate 193. Alternatively the radiating elements 121 and 122 may be disposed in the flexible substrate 191.

In an exemplary embodiment, the flexible substrate 191 and the substrate 193 are made of a material having a low dielectric constant. Using a material having a lower dielectric constant for the substrate 193 decreases the stray capacitance of conducting members, such as feeder lines and connection terminals, inside the substrate 193, thereby weakening the coupling force of a signal between adjacent conducting members. This can improve the isolation characteristics between the SiP module 105 and the connector 172.

The planar section 135A also includes the substrate 192 at a position corresponding to a portion of the flexible substrate 191 extending in the Z-axis direction. The substrate 192 is disposed on the main surface of the flexible substrate 191 in the positive direction of the Y axis. The substrate 192 is also formed of an LTCC or a resin, for example, as in the substrate 193. A radiating element 125 is disposed in the substrate 192. The substrate 192 is made of a material having a higher dielectric constant than that of the flexible substrate 191 and the substrate 193. Using a material having a higher dielectric constant for the substrate 192 can make the size of the radiating element 125 smaller. This can decrease the area of the flexible substrate 191, that is, the dimension in the Z-axis direction, compared with the configuration in which a material having a lower dielectric constant is used for the substrate 192. This contributes to reducing the height of the antenna module 100A.

In the planar section 131A, the SiP module 105 is mounted on the main surface of the flexible substrate 191 in the positive direction of the Z axis. A radio-frequency signal is supplied from the SiP module 105 to each radiating element.

In the planar section 135A, a connector 171, which is used for connecting the feeder cable 180, is disposed on the main surface of the flexible substrate 191 in the negative direction of the Y axis. The feeder cable 180 can transfer a radio-frequency signal from the SiP module 105 to a radiating element 126 disposed in a dielectric substrate 150 separately provided from the dielectric substrate 130A.

As described above, the flexible substrate 191 is used for the dielectric substrate 130A, and also, the substrate 192 made of a material having a relatively high dielectric constant is disposed in the planar section 135A and the radiating element 125 is disposed in the substrate 192, thereby making it possible to reduce the size of the radiating element 125. This can reduce the height of the antenna module 100A. Additionally, the radiating element 126 on the lower frequency side is disposed in the dielectric substrate 150, which is separately provided from the dielectric substrate 130A, and a radio-frequency signal is supplied to the radiating element 126 by using the feeder cable 180. This can make it less likely to lower the antenna gain on the lower frequency side.

In the antenna module 100 in the first embodiment, too, the planar section 135 may be made of a material having a high dielectric constant, thereby making the size of the radiating element 125 smaller and reducing the height of the antenna module 100.

The planar section 131A and the planar section 135A in the second embodiment respectively correspond to the first planar section and the second planar section in the disclosure. The flexible substrate 191 and the substrate 192 in the second embodiment respectively correspond to a first member and a second member in the disclosure. The substrate 193 in the second embodiment corresponds to the first member in the disclosure.

### Modified Example

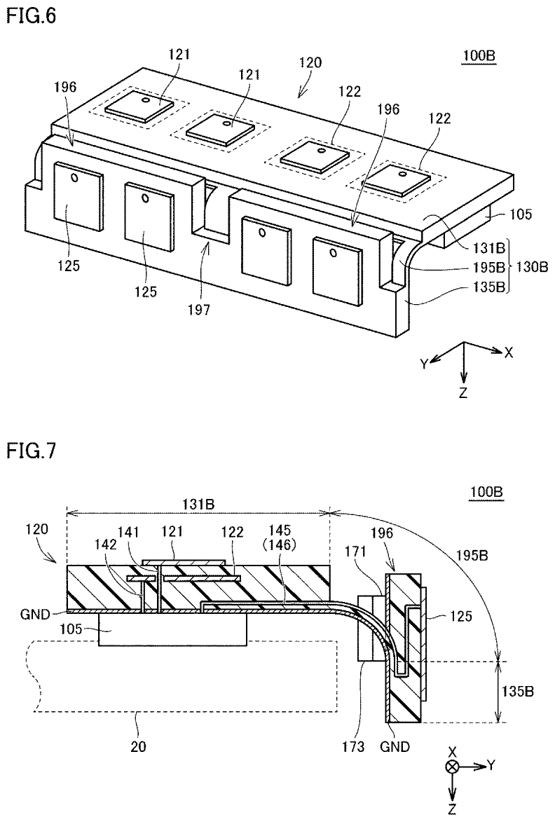

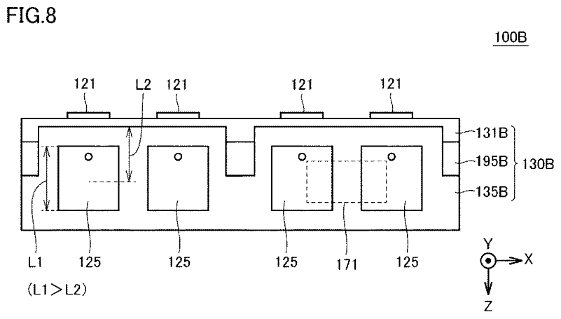

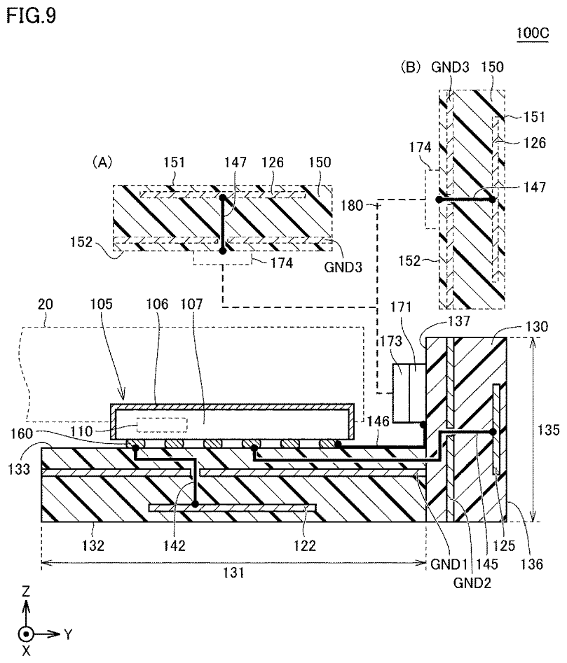

An antenna module 100B of a modified example will now be described below with reference to FIGS. 6 through 8. In the antenna module 100B of the modified example, a dielectric substrate in which radiating elements are disposed is formed of a flexible substrate. FIG. 6 is a perspective view of the antenna module 100B of the modified example. FIG. 7 is a transparent side view of the antenna module 100B in FIG. 6 as viewed from the X-axis direction. FIG. 8 is a transparent side view of the antenna module in FIG. 6 as viewed from the Y-axis direction.

As illustrated in FIGS. 6 through 8, a dielectric substrate 130B of the antenna module 100B includes planar sections 131B and 135B and a connecting section 195B.

The planar section 135B is connected to the connecting section 195B, which is bent from the planar section 131B, and is located so that the inner surface (surface in the negative direction of the Y axis) of the planar section 135B faces the side surface of a mounting substrate 20. In the planar section 135B, multiple notches 197 are formed in the dielectric substrate having a substantially rectangular shape. The connecting section 195B is connected to the notches 197. In other words, in the portions of the planar section 135B in which the notches 197 are not formed, projecting portions 196 are provided. Each projecting portion 196 projects from the boundary where the connecting section 195B and the planar section 135B are connected and extends along the planar section 135B in the direction to face the planar section 131B (that is, in the negative direction of the Z axis).

In the antenna module 100B, four radiating elements 121 are disposed on the surface of the planar section 131B along the X-axis direction. Radiating elements 122 are disposed on an inner layer of the planar section 131B so as to be associated with the radiating elements 121. A radio-frequency signal is supplied from the SiP module 105 to the radiating elements 121 via a feeder line 141. A radio-frequency signal is supplied from the SiP module 105 to the radiating elements 122 via a feeder line 142.

Two projecting portions 196 are formed in the planar section 135B of the antenna module 100B. Two radiating elements 125 are provided to correspond to each of the projecting portions 196. Each of the radiating elements 125 of the planar section 135B is disposed to at least partially overlap the associated projecting portion 196. A radio-frequency signal is supplied from the SiP module 105 to the radiating elements 125 via a feeder line 145. A radio-frequency signal is supplied to radiating elements 126 disposed in an external dielectric substrate 150, such as that discussed with reference to FIG. 3, via a feeder line 146 and connectors 171 and 173.

The feeder lines 145 and 146 and a ground electrode GND extend from the planar section 131B, passes through the connecting section 195B, and reaches the planar section 135B.

The connector 171 is disposed on the main surface of the planar section 135B in the negative direction of the Y axis. As viewed from the X-axis direction, which is perpendicular to a normal direction to the planar section 131B and also to a normal direction to the planar section 135B, the connector 171 is disposed at a position that overlaps the bending portion of the connecting section 195B. Disposing the connector 171 at such a position can effectively use a dead space produced in the connecting section 195B between the planar sections 131B and 135B, thereby contributing to reducing the size of the antenna module 100B.

As shown in FIG. 8, as viewed in the normal direction (Y-axis direction) to the planar section 135B, the connector 171 is disposed at a position at which it at least partially overlaps the radiating elements 125, e.g., the connector 171 may partially overlap, e.g., cover less than half, two adjacent radiating elements 125. As shown in FIG. 8, when the shortest distance L2 from the center of the radiating element 125 to the end portion of the planar section 135B in the polarization direction (Z-axis direction) of the radiating elements 125 is smaller than the length L1 of one side of the substantially square radiating element 125 (L1>L2), the ground electrode GND is not large enough for the radiating elements 125. This may lower the antenna gain. However, disposing the connector 171 to overlap the radiating elements 125 can strengthen the grounding function, thereby making it possible to suppress the degradation of the antenna gain.

The planar section 131B and the planar section 135B in the modified example respectively correspond to the first planar section and the second planar section in the disclosure.

### Third Embodiment

In the first and second embodiments, the radiating elements disposed in the planar section 131 are used for a dual-band antenna module. In the disclosure, a radiating element disposed in the planar section 131 is also applicable to a single-band antenna module that radiates a radio wave of a single frequency band.

FIG. 9 is a transparent side view of an antenna module 100C according to a third embodiment. The antenna module 100C includes neither of the radiating element 121 on the higher frequency side nor the feeder line 141 in the planar section 131, which are provided in the antenna module 100 in FIG. 3. The configurations of the other elements in the antenna module 100C in FIG. 9 are the same as those of the antenna module 100 in FIG. 3, and an explanation of these elements will not be repeated.

In the configuration in FIG. 9, too, the radiating element 126 on the lower frequency side, which corresponds to the radiating element 125 disposed in the planar section 135, is disposed in the dielectric substrate 150 separately provided from the dielectric substrate 130, and a radio-frequency signal is supplied to the radiating element 126 via the connector 171 of the planar section 135. By providing the radiating element 126 externally to the dielectric substrate and separate from the radiating element 125, the radiating element 126 can be disposed where more space is available in a communication apparatus. This can ease the limitation on the area of the ground electrode for the radiating element 126, compared with the configuration in which the radiating element 126 is stacked on the radiating element 125. Hence, in an antenna module that can radiate a radio wave in two different directions, the antenna gain on the lower frequency side is less likely to be lowered.

In FIG. 9, the radiating element 122 on the lower frequency side is only disposed in the planar section 131. Alternatively, the radiating element 122 on the lower frequency side may be removed, and only the radiating element 121 on the higher frequency side may be disposed.

The radiating element 122, radiating element 125, and radiating element 126 in the third embodiment respectively correspond to a fifth radiating element, a sixth radiating element, and a seventh radiating element in the disclosure. In other words, the fifth radiating element corresponds to the first or second radiating element in the first embodiment, the sixth radiating element corresponds to the second radiating element in the first embodiment, and the seventh radiating element corresponds to the fourth radiating element in the first embodiment. However, regardless of the labeling herein, the numbering of the radiating element in the claims is based on an order in which they are introduced in the claims and are defined by their respective relationships recited in the claims.

### Aspects

(1) An antenna module according to an aspect is configured to receive a signal from a baseband circuit and to radiate a radio wave. The antenna module includes a dielectric substrate, first and second radiating elements, and a first connector. The dielectric substrate includes first and second planar sections. The normal direction to the first planar section and that to the second planar section are different from each other. The first radiating element is disposed in or on the first planar section. The second radiating element is disposed in or on the second planar section. The antenna module is configured to transfer a radio-frequency signal to a third radiating element, which is disposed externally to the dielectric substrate, via the first connector. The size of the second radiating element is smaller than that of the third radiating element.

(2) In the antenna module according to (1), the first connector is disposed on the second planar section.

(3) The antenna module according to (2) further includes a second connector and a control circuit. The second connector receives a signal from a baseband circuit. The control circuit is configured to receive the signal from the second connector, convert the signal into a radio-frequency signal, and supply the radio-frequency signal to each of the first through third radiating elements. The first planar section has first and second surfaces facing each other. The first radiating element is disposed to radiate a radio wave from the first surface. The second connector and the control circuit are disposed on the second surface.

(4) In the antenna module according to (3), the second planar section has third and fourth surfaces facing each other. The first planar section is disposed closer to the fourth surface than to the third surface. The second radiating element is disposed to radiate a radio wave from the third surface. The first connector is disposed on the fourth surface.

(5) In the antenna module according to (4), the second planar section is disposed such that the fourth surface faces the second surface.

(6) In the antenna module according to (4), the second planar section includes a first member having a first dielectric constant and a second member having a second dielectric constant which is higher than the first dielectric constant. The second member is disposed closer to the third surface than the first member is. The second radiating element is disposed in or on the second member.

(7) In the antenna module according to one of (3) to (6), a shield is provided on a peripheral portion of the control circuit to contain an electromagnetic wave in the control circuit. When the second connector is seen from the first connector, at least part of the second connector overlaps the control circuit.

(8) The antenna module according to one of (3) to (7), as viewed from a normal direction to the first planar section, the first connector has a substantially rectangular shape having long sides and short sides and is disposed to be adjacent to the control circuit in a direction of the short sides.

(9) In the antenna module according to one of (3) to (8), as viewed from a normal direction to the second planar section, at least part of the first connector overlaps the control circuit.

(10) In the antenna module according to one of (3) to (9), the second connector is disposed on the first planar section at a position at which the second connector does not overlap the second planar section.

(11) In the antenna module according to one of (2) to (10), as viewed from a normal direction to the second planar section, the first connector has a substantially rectangular shape having long sides and short sides, and the first connector is disposed on the second planar section such that a line extending in a direction along the short sides intersects with the first planar section.

(12) In the antenna module according to one of (2) to (11), the dielectric substrate further includes a connecting section that connects the first planar section and the second planar section with each other.

(13) In the antenna module according to (12), the connecting section includes a bending portion.

(14) In the antenna module according to (13), as viewed from a direction perpendicular to a normal direction to the first planar section and to a normal direction to the second planar section, the first connector overlaps the bending portion.

(15) In the antenna module according to (14), the second radiating element has a substantially square shape. As viewed from a normal direction to the second planar section, the shortest distance from the center of the second radiating element to an end portion of the second planar section in a polarization direction of the second radiating element is smaller than a length of one side of the second radiating element, and at least part of the first connector overlaps the second radiating element.

(16) In the antenna module according to (13), the connecting section has flexibility.

(17) In the antenna module according to one of (2) to (16), a normal direction to the first planar section is perpendicular to a normal direction to the second planar section.

(18) In the antenna module according to one of (2) to (17), the antenna module includes a fourth radiating element disposed in or on the first planar section. The size of the fourth radiating element is different than that of the first radiating element.

(19) In the antenna module according to (18), the first radiating element and the fourth radiating element are stacked.

(20) A communication apparatus according to an aspect includes the antenna module according to one of (1) to (19).

The disclosed embodiments are provided only for the purposes of illustration, but are not intended to be exhaustive or to limit the disclosure to the precise forms disclosed. It is intended that the scope of the disclosure be defined, not by the foregoing embodiments, but by the following claims. The scope of the present disclosure is to be accorded the broadest interpretation so as to encompass all such modifications and equivalent structures and functions.

What is claimed is:

1. An antenna module comprising:
a dielectric substrate including first and second planar sections, a normal direction to the first planar section and a normal direction to the second planar section being different from each other;
a first radiating element disposed in or on the first planar section;
a second radiating element disposed in or on the second planar section; and
a first connector, wherein
the antenna module is configured to transfer a radio-frequency signal to a third radiating element via the first connector, the third radiating element being disposed externally to the dielectric substrate,
a size of the second radiating element is smaller than a size of the third radiating element, and
the third radiating element is attachable to and detachable from the dielectric substrate by the first connector.

2. The antenna module according to claim 1, wherein the first connector is disposed on the second planar section.

3. The antenna module according to claim 2, further comprising:
a baseband circuit;
a second connector that receives a signal from the baseband circuit; and
a control circuit configured to receive the signal from the second connector, convert the signal into a radio-frequency signal and supply the radio-frequency signal to each of the first through third radiating elements, wherein
the first planar section has first and second surfaces facing each other,
the first radiating element is disposed to radiate a radio wave from the first surface, and
the second connector and the control circuit are disposed on the second surface.

4. The antenna module according to claim 3, wherein:
the second planar section has third and fourth surfaces facing each other;
the first planar section is closer to the fourth surface than to the third surface,
the second radiating element is disposed to radiate a radio wave from the third surface, and
the first connector is disposed on the fourth surface.

5. The antenna module according to claim 4, wherein the second planar section is disposed such that the fourth surface faces the second surface.

6. The antenna module according to claim 4, wherein:
the second planar section includes
a first member having a first dielectric constant, and
a second member that is disposed closer to the third surface than the first member is and that has a second dielectric constant which is higher than the first dielectric constant; and
the third radiating element is disposed in or on the second member.

7. The antenna module according to claim 3, further comprising:
a shield on a peripheral portion of the control circuit to contain an electromagnetic wave in the control circuit; and
when the second connector is seen from the first connector, at least part of the second connector overlaps the control circuit.

8. The antenna module according to claim 3, wherein, as viewed from a normal direction to the first planar section, the first planar section has a substantially rectangular shape having long sides and short sides, and the first connector is disposed to be adjacent to the control circuit in a direction of the short sides.

9. The antenna module according to claim 3, wherein, as viewed from a normal direction to the second planar section, at least part of the first connector overlaps the control circuit.

10. The antenna module according to claim 3, wherein, as viewed from a normal direction to the second planar section, the second connector is disposed on the first planar section at a position at which the second connector does not overlap the second planar section.

11. The antenna module according to claim 2, wherein, as viewed from a normal direction to the second planar section, the first connector has a substantially rectangular shape having long sides and short sides, and the first connector is disposed on the second planar section such that a line extending in a direction along the short sides intersects with the first planar section.

12. The antenna module according to claim 2, wherein the dielectric substrate further includes a connecting section that connects the first planar section and the second planar section with each other.

13. The antenna module according to claim 12, wherein the connecting section includes a bending portion.

14. The antenna module according to claim 13, wherein, as viewed from a direction perpendicular to a normal line to the first planar section and to a normal line to the second planar section, the first connector overlaps the bending portion.

15. The antenna module according to claim 14, wherein:
the second radiating element has a substantially square shape; and
as viewed from a normal direction to the second planar section,
a shortest distance from a center of the second radiating element to an end portion of the second planar section in a polarization direction of the second radiating element is smaller than a length of one side of the second radiating element, and
at least part of the first connector overlaps the third radiating element.

16. The antenna module according to claim 13, wherein the connecting section has flexibility.

17. The antenna module according to claim 2, wherein a normal direction to the first planar section is perpendicular to a normal direction to the second planar section.

18. The antenna module according to claim 1, further comprising
a fourth radiating element disposed in or on the first planar section;
wherein
a size of the fourth radiating element is different than a size of the first radiating element.

19. The antenna module according to claim 18, wherein the fourth radiating element and the first radiating element are stacked.

20. A communication apparatus comprising:
the antenna module according to one of claim 1.
